(19) United States
(12) Patent Application Publication
(10) Pub. No.: US 2016/0099080 A1
(43) Pub. Date: Apr. 7, 2016

(54) NUCLEAR FUEL ELEMENT CORRUGATED PLENUM HOLDDOWN DEVICE

(71) Applicant: Westinghouse Electric Company LLC, Cranberry Township, PA (US)

(72) Inventors: Joonhyung Choi, Lexington, SC (US); Peng Xu, Columbia, SC (US)

(73) Assignee: Westinghouse Electric Company LLC, Cranberry Township, PA (US)

(21) Appl. No.: 14/503,443

(22) Filed: Oct. 1, 2014

(51) Int. Cl. G21C 3/18

(52) U.S. Cl. CPC G21C 3/18

(57) ABSTRACT

A fuel rod having a gas plenum holddown device that occupies less volume than a conventional spiral spring and is formed from a bellows-like, resilient tubular member having a hollow interior volume open to the gas plenum and an exterior sheath formed from a plurality of alternating ridges and troughs stacked in tandem and interconnected.

### BACKGROUND

1. Technical Field

This invention pertains generally to a nuclear reactor core component and, more particularly, to components such as fuel rods and control rods that employ an active ingredient within a cladding that is held in position by a plenum spring.

2. Related Art

The primary side of nuclear power generating systems which are cooled with water under pressure comprise a closed circuit which is isolated and in heat exchange relationship with a secondary side for the production of useful energy. The primary side includes the reactor vessel enclosing a core internal structure that supports a plurality of fuel assemblies containing fissile material, the primary circuit within heat exchange steam generators, the inner volume of a pressurizer, pumps and pipes for circulating pressurized water; the pipes connecting each of the steam generators and pumps to the reactor vessel independently. Each of the parts of the primary side comprising a steam generator, a pump and a system of pipes which are connected to the vessel form a loop of the primary side. The fission reactions within the fuel assemblies within the core of the reactor vessel are the source of heat which are transferred to the secondary side through the steam generators for the production of useful work.

A typical fuel assembly for a pressurized water reactor is shown in FIG. 1 as an elevational view, represented in vertically shortened form generally designated by reference character 10. The fuel assembly 10 has a structural skeleton which, at its lower end, includes a bottom nozzle 12. The bottom nozzle 12 supports the fuel assembly 10 on a lower core support plate 14 in the core region of the nuclear reactor. In addition to the bottom nozzle 12, the structural skeleton of the fuel assembly 10 also includes a top nozzle 16 at its upper end and a number of guide thimbles 18, which extend longitudinally between the bottom and top nozzles 14 and 16 and at opposite ends are rigidly attached thereto.

The fuel assembly 10 further includes a plurality of transverse grids 20 axially spaced along and mounted to the guide thimbles 18 (also referred to as guide tubes) and an organized, array of elongated fuel rods 22 transversely spaced and supported by the grids 20. Although it cannot be seen in FIG. 1, the grids 20 are conventionally formed from orthogonal straps that are interleaved in an egg-crate pattern with the adjacent interface of four straps defining approximately square support cells through which the fuel rods 22 are supported in transversely spaced relationship with each other. In many conventional designs, springs and dimples are stamped into the opposing walls of the straps that form the support cells. The springs and dimples extend radially into the support cells and capture the fuel rods therebetween; exerting pressure on the fuel rod cladding to hold the rods in position. Also, the assembly 10 has an instrumentation tube 24 located in the center thereof that extends between and is mounted to the bottom and top nozzles 12 and 16. With such an arrangement of parts, fuel assembly 10 forms an integral unit capable of being conventionally handled without damaging the assembly of parts.

As mentioned above, the fuel rods 22 in the array thereof in the assembly 10 are held in spaced relationship with one another by the grids 20 spaced along the fuel assembly length. Each fuel rod 22 includes a plurality of nuclear fuel pellets 24 and is closed at its opposite ends by upper and lower end plugs 26 and 28. The fuel pellets 24, composed of fissile material, are responsible for creating the reactive power of the reactor. The cladding which surrounds the pellets functions as a barrier to prevent fission by-products from entering the coolant and further contaminating the reactor system.

To control the fission process, a number of control rods 30 are reciprocally movable in the guide thimbles 18 located at predetermined positions in the fuel assembly 10. Specifically, a rod cluster control mechanism 32, positioned above the top nozzle 16 supports the control rods 30. The control mechanism 32 has an internally threaded cylindrical hub member 34 with a plurality of radially extending flukes or arms 36. Each arm 36 is interconnected to at least one of the control rods 18 such that the control rod mechanism 32 is operable to move the control rods vertically in the guide thimbles 18 to thereby control the fission process in the fuel assembly 10, under the motive power of a control rod drive shaft (not shown) which is coupled to the control rod hub 34, all in a well-known manner.

The fuel assemblies 10 are subject to hydraulic forces that exceed the weight of the fuel rods and thereby exert significant forces on the fuel rods and the fuel assemblies. In addition, there is significant turbulence in the coolant in the core caused by mixing vanes on the upper surfaces of the straps of many grids, which promote the transfer of heat from the fuel rod cladding to the coolant. The substantial flow forces and turbulence can result in vibration of the fuel rod cladding which can damage the fuel pellets 24 if they are not restrained. To prevent any damage to the fuel pellets during shipping, operation in the reactor and handling during loading, repositioning and removal of the nuclear fuel assembly, a holddown device 38 is inserted into the fuel rod 22 to provide a minimum preload of four times of the pellets' stack weight. Typically, a coil spring with a uniform pitch 40, as shown in FIG. 1, or a variable pitch 42, as shown in FIG. 2, has been used for many years. Also, the volume that the holddown device 38 occupies within the plenum 44, above the fuel pellets stack 24, should be minimized to provide sufficient plenum volume to prevent excessive stresses on the cladding due to an internal pressure buildup by fission gas release from the fuel as a by-product of the fission reaction. The preloaded coil spring, however, relaxes rather quickly in the high temperature and irradiation environment within the reactor; risking pellet chipping during relocation of the fuel assemblies during the refueling process or offloading of the fuel assemblies for storage. A sharp pellet chip may induce pellet-cladding-mechanical-interaction fuel failures. The spiral coil spring has also been found to be susceptible to buckling or cocking during the welding process that affixes the upper end plug to the cladding.

An alternative holddown device that has been employed in one type of wet annular burnable absorber rodlets is the spring clip design shown in FIG. 3A and FIG. 3B. This design, in a compressed state has a smaller diameter than the plenum, but opens up to pressure the plenum walls to maintain its position biasing the fuel pellets towards the lower end plug. However, the spring clip design introduces a serious risk of excessive hoop stress on the cladding since the 4 g axial holddown force that is required is generated by friction between the clip and cladding, which requires a relatively large radial force that could generate excessive hoop stresses in the cladding. Also, this design may not be able to absorb the additional pellet stack length increase that the fuel rod experiences as a result of bowing during handling. Furthermore, once the clip slides, it will not return to its original location resulting in an axial gap that will lessen or remove the 4 g holddown force on the pellet stack. The clip's preload force may also disappear as a result of the thermal and irradiation effects during operation which could also lessen the preload force.

Another proposed alternative to the spiral spring is disclosed in U.S. Pat. No. 3,679,545 which describes a holddown device that is helically corrugated over its entire length to provide improved radial support of the cladding than is provided by a typical helical coil spring. This device occupies a larger volume of the plenum than the helical coil spring would occupy and its helical geometry can result in excessive twisting or bowing of the holddown device.

An additional alternative is disclosed in U.S. Pat. No. 4,684,504 which describes a sealed expanded bellows where the internal pressurization generates the holddown force on the pellet stack as well as radial support of the cladding. However, this device may not provide the plenum volume required to accommodate the fission gas release from the fuel pellets.

Accordingly, an improved means of holding down the fuel pellets within a fuel element cladding is desired that will provide uniform pressure on the upper surface of the top pellet in the pellet stack.

Additionally, such an improved design is desired that will facilitate installation, limit consequences of unlikely installation mistakes and minimize potential performance issues.

Furthermore, a new holddown device is desired that will increase the plenum volume efficiently.

### SUMMARY

These and other objects are achieved by an improved elongated reactive member, such as a fuel element or control rod, for use in a nuclear core. The reactive member is formed from a tubular cladding substantially extending the elongated length of the reactive member with a top end plug sealing off a top end of a central hollow cavity of the tubular cladding and a bottom end plug sealing off a bottom end of the central hollow cavity of the tubular cladding. A lower end plug sealably closes off a lower end of the tubular cladding and a column of reactive material occupies a lower portion of the interior of the tubular cladding above the lower end plug. An upper end plug sealably closes off an upper end of the tubular cladding defining a gas plenum substantially occupying the internal volume of the tubular cladding above the column of reactive material and below the upper end of the tubular cladding. A restraining device is supported above a top of the column of reactive material for pressuring the column of reactive material towards the lower end plug to restrain the reactive material from movement. The restraining device comprises a bellows-like, resilient tubular member having a hollow interior volume and an exterior sheath formed from a plurality of alternating ridges and troughs stacked in tandem. Preferably, the bellows-like resilient tubular member has a Fillet Radius approximately between 0.002-0.020 inches (0.005-0.051 cm.); a Major Radius approximately between 0.010-0.100 inches (0.025-0.254 cm.); a Minor Radius approximately between 0.005-0.080 inches (0.013-0.203 cm.); an Inner Diameter approximately between 0.100-0.350 inches (0.254-0.889 cm.); and Wall Thickness approximately between 0.002-0.010 inches (0.005-0.025 cm.). Desirably, the bellows-like resilient tubular member has a total number of ridges approximately within the range of 5-100.

In one embodiment, the elongated reactive member has a tubular cladding formed from silicon carbide and the bellows-like resilient member is constructed from one or more materials selected from a group of materials consisting of Molybdenum, Tungsten, a Nickel Iron alloy, Zirconium and Hafnium. In another embodiment, the bellows-like resilient tubular member has a thermal barrier coating extending over at least part of an outer surface and preferably, the thermal barrier coating is a low conductivity oxide or a pyrochlore compound.

The invention also contemplates a nuclear fuel assembly including a plurality of fuel rods comprising the elongated reactive member. In still another embodiment, the invention contemplates a control rod cluster assembly in which the control rods comprise the elongated reactive member.

### BRIEF DESCRIPTION OF THE DRAWINGS

A further understanding of the invention can be gained from the following description of the preferred embodiments when read in conjunction with the accompanying drawings in which:

FIG. 1 is an elevational view, partially in section, of a fuel assembly illustrated in vertically shortened form, with parts broken away for clarity;

FIG. 2 is a plan view of a typical fuel rod plenum variable pitch coil spring;

FIG. 3A is a perspective view of a fuel rod plenum spring clip design;

FIG. 3B is a plan view of the spring clip design shown in FIG. 3A;

FIG. 4 is an elevational view of a fuel rod bellow plenum spring in accordance with one embodiment of this invention;

FIG. 5 is a side view partially in section of the upper portion of a fuel rod showing the plenum spring of FIG. 4 installed between the fuel pellets and the upper end plug;

FIG. 6 is a schematic diagram showing the different dimensional points on the bellows spring illustrated in FIGS. 4 and 5; and

FIG. 7 is a graphical representation of the load deflection curve of the bellows spring illustrated in FIGS. 4 and 5.

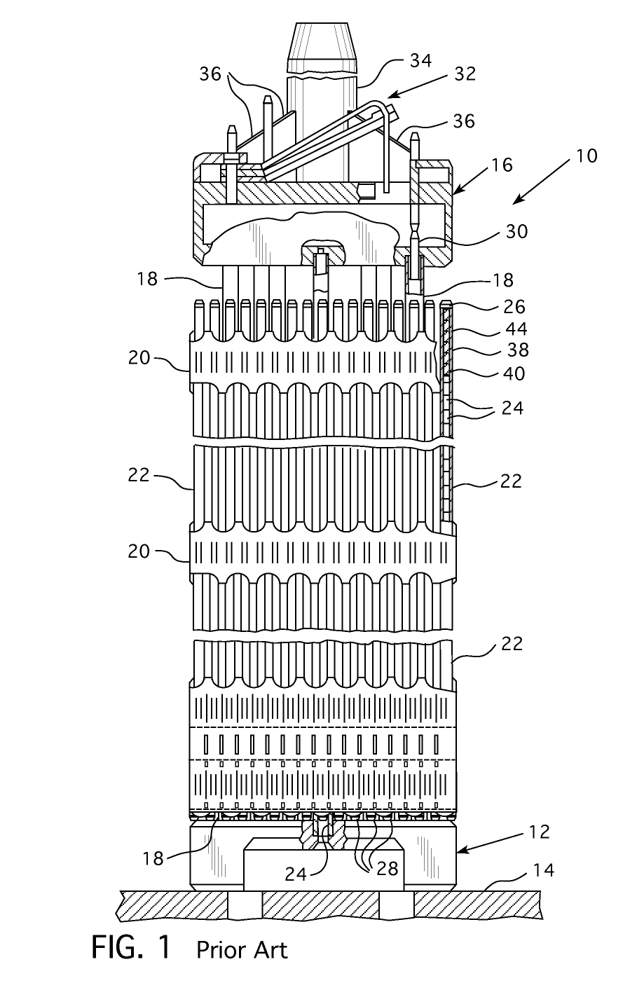

### DESCRIPTION OF THE PREFERRED EMBODIMENT

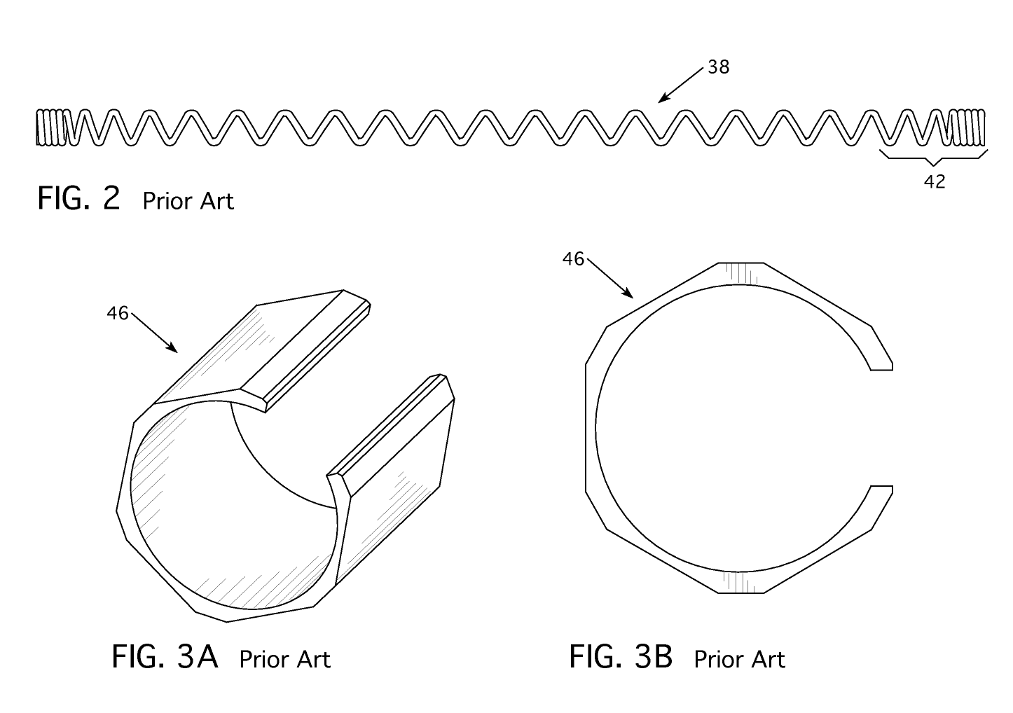

Nuclear power electrical generating stations are a very efficient and cost-effective source of electricity as long as they are running Unforced outages, such as for refueling, considerably raise the cost of power, because they require expensive replacement power to be purchased over the length of the outage. Accordingly, increasing the time between outages is a desired objective. One way to increase core residence time of a fuel assembly is to load more uranium in the fuel rods. There are several possible ways to accomplish that objective, such as employing longer pellet stacks, enlarged pellet diameters, or higher density fuel. However, these modifications require more plenum volume to accommodate the volume changes of the pellets and accommodate the increase fission gas release. Within the limited plenum volume, it is not easy for a coil spring to achieve the 4 g holddown force required. When the coil spring is compressed, the shear stress, dynamic expansion and solid height requirements have to be satisfied. In fact, the current variable pitch plenum spring shown in FIG. 2, with the coils more closely packed at the ends than over the longer center length as shown at reference character 42 is the most optimized design currently in use.

Another possible holddown device currently in use in wet annular burnable absorber rodlets is a spring clip design 46 shown in FIGS. 3A and 3B. This design can increase the plenum volume in a fuel rod to a relatively large degree. However, there could be a serious risk of excessive hoop stress on the cladding because the axial holddown force that the spring clip needs to impart on the fuel pellets has to be generated by the friction between the clip and cladding, which means that the clip needs to produce a high radial force on the cladding that could result in excessive hoop stress on the cladding. Also, this design may not be able to absorb additional pellet stack length increase resulting from fuel rod bowing that can occur during handling. Once the clip slides, it will not return to its original location resulting in an axial gap that can relieve the 4 g holddown force on the pellet stack. The clip's pre-load force can also diminish during operation as a result of the high temperatures and irradiation effects.

Another possible alternative to the spiral spring is disclosed in U.S. Pat. No. 3,679,545 which describes a helically corrugated tubular holddown device that provides better radial support of the cladding than a typical helical coil spring. However, it occupies a larger volume than a coil spring and its helical geometry can result in excessive twisting or bowing of the spring.

Another alternative is disclosed in U.S. Pat. No. 4,684,504 which describes an expanded sealed bellows where the internal pressure within the bellows generates the holddown force on the pellet stack as well as radial support for the cladding. This design, however, occupies more plenum volume than the helically corrugated design of U.S. Pat. No. 3,679,545 and will likely not accommodate the fission gases released from the fuel pellets if it was employed within a fuel rod plenum.

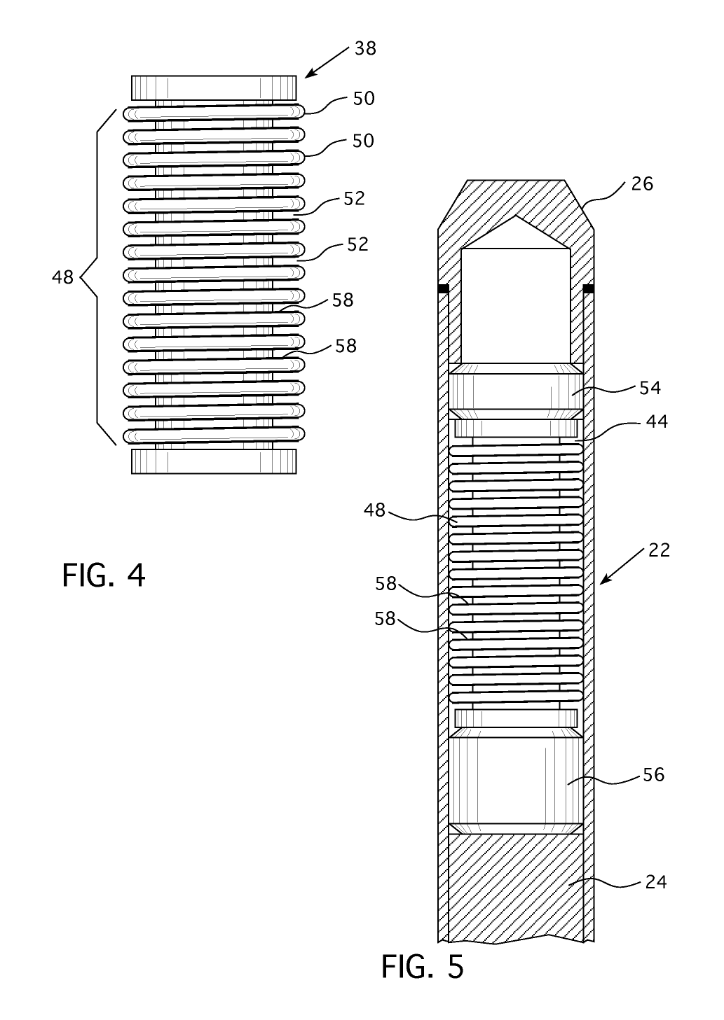

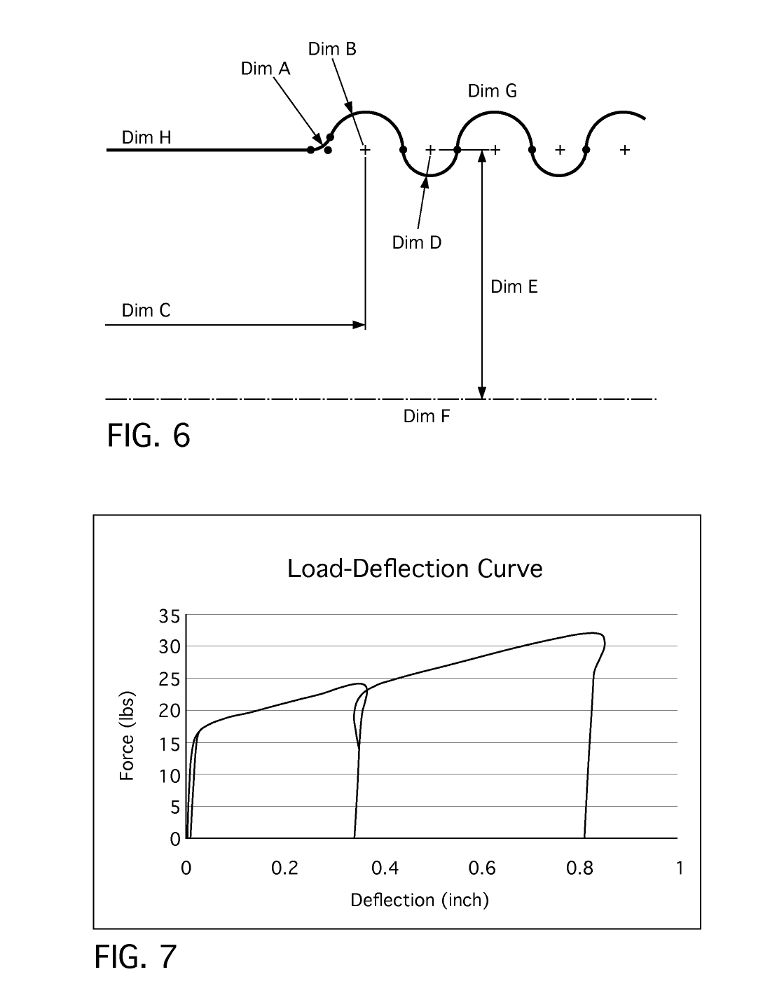

This invention employs a holddown or restraining device that can better withstand the effects of irradiation and high temperatures to maintain an adequate force to holddown the fuel pellets over their operating life and occupies less plenum volume than a spiral spring. One embodiment of the restraining device 38 is shown in FIG. 4. The device is a bellows-like, resilient tubular member 48 having a hollow interior volume open to the gas plenum and an exterior sheath formed from a plurality of alternating ridges 50 and troughs 52 stacked in tandem and interconnected. The device is a corrugated thin walled holddown device that will replace the conventional coil spring to reduce the volume occupied by the holddown device and provide the required holddown force. The dimensions identified in FIG. 6 and set forth in the following Table 1 are critical toward that goal.

TABLE 1
Dimensional Specification for the Holddown Device

| Dimension | Description | Range (inch) | Design considerations |
|---|---|---|---|
| A | Fillet Radius | 0.002-0.020 | Minimize local stress |
| B | Major Radius | 0.010-0.100 | Interference with cladding |
| | | | inner diameter |
| C | 1^{st} Peak Location | as required | Manufacturability |
| D | Minor Radius | 0.005-0.080 | Stiffness |
| E | Inner Diameter | 0.100-0.350 | Plenum volume and |
| | | | cladding support |
| F | Total Length | as required | 4 g holddown force |
| G | Total Number of | 5 to 100 | |
| | Peaks | | |
| H | Wall Thickness | 0.002-0.010 | Stiffness & plenum volume |

Finite element analysis confirmed that most compressions occur by elastic and plastic deformations of the corrugated region without diametric expansion. FIG. 5 shows the bellows member 48 installed within the plenum 44 of a fuel rod 22 with a lower spacer 56 installed between the fuel pellets 24 and the bellows 48 and an upper spacer 54 installed between the bellows 48 and the upper end cap 26. The load deflection characteristics are shown in FIG. 7. The unique nonlinearity that the curves demonstrate, with high elastic stiffness will provide sufficient holddown force even after experiencing the thermal and irradiation effects during the fuel rods operating life.

The bellows plenum spring 48 may be used with a silicon carbide cladding provided the bellows is made of a low thermal expansion co-efficient material with a high melting point, such as Molybdenum or Tungsten or INBAR-36® (36% Nickel and 64% Iron). A thermal barrier coating can be deposited on the parts of the device experiencing the highest temperatures, such as the portions nearest the fuel and nearest the upper end cap, to prevent the device from overheating. The thermal barrier coating materials can be a variety of low thermal conductivity oxides such as ZrO₂ or Pyrochlore compounds, i.e., Nd₂CR₂O₇. The thermal barrier coating can be applied only to the heat effective zone, mainly the ends of the device which are in contact with the fuel pellets and the upper end plug. The thermal barrier coating can be applied using plasma spray, chemical vapor deposition, physical vapor deposition, cold spray or thermal spray. Accordingly, as compared to a typical plenum coil spring, this invention will provide added plenum volume to allow more uranium to be loaded into the fuel rods. In addition, it will provide sufficient holddown force on the irradiated pellet stacks to prevent pellet damage during shipping and handling. This device also provides better radial support of the cladding than the spiral coil spring. Using refractory materials this invention can withstand the high temperature environment anticipated for a silicon carbide clad fuel rod.

While specific embodiments of the invention have been described in detail, it will be appreciated by those skilled in the art that various modifications and alternatives to those details could be developed in light of the overall teachings of the disclosure. Accordingly, the particular embodiments disclosed are meant to be illustrative only and not limiting as to the scope of the invention which is to be given the full breadth of the appended claims and any and all equivalents thereof.

What is claimed is:

1. An elongated, reactive member for use in a nuclear core comprising:
a tubular cladding substantially extending an elongated length of the reactive member;
a lower end plug sealably closing off a lower end of the tubular cladding;
a column of reactive material occupying a lower portion of the interior of the tubular cladding;
an upper end plug sealably closing off an upper end of the tubular cladding;
a gas plenum substantially occupying an internal volume of the tubular cladding above the column of reactive material, below the upper end of the tubular cladding; and
a restraining device supported above a top of the column of reactive material for pressuring the column of reactive material toward the lower end plug to restrain the reactive material from movement, the restraining device comprising:
a bellows like, resilient tubular member having a hollow interior volume open to the gas plenum and an exterior sheath formed from a plurality of alternating ridges and troughs stacked in tandem.

2. The elongated, reactive member of claim 1 wherein the bellows like, resilient tubular member has a Fillet Radius approximately between 0.002-0.020 inches (0.005-0.051 cm.).

3. The elongated, reactive member of claim 1 wherein the bellows like, resilient tubular member has a Major Radius approximately between 0.010-0.100 inches (0.025-0.254 cm.).

4. The elongated, reactive member of claim 1 wherein the bellows like, resilient tubular member has a Minor Radius approximately between 0.005-0.080 inches (0.013-0.203 cm.).

5. The elongated, reactive member of claim 1 wherein the bellows like, resilient tubular member has an Inner Diameter approximately between 0.100-0.350 inches (0.254-0.889 cm.).

6. The elongated, reactive member of claim 1 wherein the bellows like, resilient tubular member has a total number of ridges approximately within the range of 5-100.

7. The elongated, reactive member of claim 1 wherein the bellows like, resilient tubular member has a Wall Thickness approximately between 0.002-0.010 inches (0.005-0.025 cm.).

8. The elongated, reactive member of claim 1 wherein the tubular cladding is formed from Silicon Carbide and the bellows like, resilient member is constructed from one or more materials selected from a group of materials consisting of Molybdenum, Tungsten, a Nickel Iron alloy, Zirconium and Hafnium.

9. The elongated, reactive member of claim 1 wherein the bellows like, resilient tubular member has a thermal barrier coating extending over at least part of an outer surface.

10. The elongated, reactive member of claim 9 wherein the thermal barrier coating is a low conductivity oxide or a pyrochlore compound.

11. A nuclear fuel assembly including a plurality of fuel rods respectively comprising:
a tubular cladding;
a lower end plug sealably closing off a lower end of the tubular cladding;
a column of fissile material occupying a lower portion of the interior of the tubular cladding;
an upper end plug sealably closing off an upper end of the tubular cladding;
a gas plenum substantially occupying an internal volume of the tubular cladding above the column of fissile material, below the upper end of the tubular cladding; and
a restraining device supported above a top of the column of fissile material for pressuring the column of fissile material toward the lower end plug to restrain the fissile material from movement, the restraining device comprising:
a bellows like, resilient tubular member having a hollow interior volume open to the gas plenum and an exterior sheath formed from a plurality of alternating ridges and troughs stacked in tandem.

12. The nuclear fuel assembly of claim 11 wherein the bellows like, resilient tubular member has a Fillet Radius approximately between 0.002-0.020 inches (0.005-0.051 cm.).

13. The nuclear fuel assembly of claim 11 wherein the bellows like, resilient tubular member has a Major Radius approximately between 0.010-0.100 inches (0.025-0.254 cm.).

14. The nuclear fuel assembly of claim 11 wherein the bellows like, resilient tubular member has a Minor Radius approximately between 0.005-0.080 inches (0.013-0.203 cm.).

15. The nuclear fuel assembly of claim 11 wherein the bellows like, resilient tubular member has an Inner Diameter approximately between 0.100-0.350 inches (0.254-0.889 cm.).

16. The nuclear fuel assembly of claim 11 wherein the bellows like, resilient tubular member has a total number of ridges approximately within the range of 5-100.

17. The nuclear fuel assembly of claim 11 wherein the bellows like, resilient tubular member has a Wall Thickness approximately between 0.002-0.010 inches (0.005-0.025 cm.).

18. The nuclear fuel assembly of claim 11 wherein the tubular cladding is formed from Silicon Carbide and the bellows like, resilient member is constructed from one or more materials selected from a group of materials consisting of Molybdenum, Tungsten, a Nickel Iron alloy, Zirconium and Hafnium.

19. The nuclear fuel assembly of claim 11 wherein the bellows like, resilient tubular member has a thermal barrier coating extending over at least part of an outer surface.

20. The nuclear fuel assembly of claim 19 wherein the thermal barrier coating is a low conductivity oxide or a pyrochlore compound.
